(19) United States
(12) Patent Application Publication
(10) Pub. No.: US 2009/0113403 A1
(43) Pub. Date: Apr. 30, 2009

(54) Replacing no operations with auxiliary code

(75) Inventors: John Davis, San Francisco, CA (US); Ulfar Erlingsson, San Francisco, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/904,501

(22) Filed: Sep. 27, 2007

(51) Int. Cl. G06F 9/45

(52) U.S. Cl. 717/146

(57) ABSTRACT

A machine code computer program may comprise machine code directed to a main task and may contain no operations (NOPs). Some or all of the NOPs may be replaced with auxiliary code. Alternatively, the machine code computer program may be generated with auxiliary code where the NOPs would otherwise be. In some implementations, additional auxiliary code may also be provided in the machine code computer program. The auxiliary code and additional auxiliary code may comprise instructions that provide additional information about the machine code computer program in which they reside and its execution, but otherwise may act as NOPs with regard to the functionality of the machine code computer program.

### BACKGROUND

A machine code computer program may comprise no operations (NOPs) that are placed into the machine code by a compiler when compiling source code into the machine code. NOPs are instructions that do nothing at all, except consume processor clock cycles. NOPs are commonly used for timing purposes, to force memory alignment, or to occupy a branch delay slot. NOPs do not affect the output of the computations that result during the execution of the sequence of instructions or affect the output of the task to which the machine code is directed. Therefore, memory space utilized by NOPs is generally wasted.

### SUMMARY

A machine code computer program may comprise main machine code directed to a main task and may contain no operations (NOPs). Some or all of the NOPs may be replaced with auxiliary code. Alternatively, the machine code computer program may be generated with auxiliary code where the NOPs would otherwise be. In some implementations, additional auxiliary code may also be provided in the machine code computer program.

The memory space that is utilized by NOPs can be occupied by auxiliary code. Auxiliary code may comprise instructions that provide additional information about the machine code computer program and its execution, but otherwise may act as NOPs with regard to the functionality of the machine code computer program. Therefore, by replacing NOPs with auxiliary code, additional information about the machine code computer program may be provided without increasing the size of the machine code computer program.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1A is a block diagram of an implementation of a system that may be used to replace no operations (NOPs) with auxiliary code;

FIG. 1B is a block diagram of another implementation of a system that may be used to replace NOPs with auxiliary code;

FIG. 2 is an operational flow of an implementation of a method of replacing one or more NOPs with auxiliary code;

FIG. 3 is an operational flow of another implementation of a method of replacing one or more NOPs with auxiliary code;

FIG. 4 is an operational flow of an implementation of a method of replacing NOPs with auxiliary code based on the availability of NOPs;

FIG. 5 is an operational flow of another implementation of a method of replacing NOPs with auxiliary code based on the availability of NOPs;

FIG. 6 is an operational flow of an implementation of a method of executing auxiliary code that has replaced one or more NOPs in machine code;

FIG. 7 is an operational flow of an implementation of a method in which a dynamic bubble may be used in conjunction with auxiliary code; and

FIG. 8 is a block diagram of an example computing environment in which example embodiments and aspects may be implemented.

### DETAILED DESCRIPTION

Optimizing the compilation of a computer program is disclosed herein. A computer program may include a main code, no operations (NOPs), and auxiliary code. The main code may comprise a sequence of instructions that is directly related to the main task of the computer program. The auxiliary code may be code directed to check the computations, control flow paths, or other information that result during the execution of the sequence of instructions. As such, the auxiliary code may be configured to perform a task that is unrelated to the main task of the main code. As a result, the auxiliary code may not affect the output of the computations of the main task.

In an implementation, the auxiliary code may be used to replace NOPs within the computer program, thus resulting in large performance gains. In an embodiment, the computer program may be precompiled into an intermediate state. The main code, the NOPs, and the auxiliary code may be in machine code. As such, the NOPs in machine code may be replaced by at least a portion of the auxiliary code which is also in machine code. In another embodiment, the computer program may be in source code. Thus, the main code, the NOPs, and the auxiliary code may be in source code. The NOPs in source code may be replaced by at least a portion of the auxiliary code which is also in source code.

Replacing NOPs with auxiliary code may be particularly effective for reduced instruction set computer (RISC) architectures and very long instruction word (VLIW) architectures that generally execute machine code that already contain NOPs. However, the replacement of NOPs with auxiliary code is not restricted to these processor architectures and may be applied to any processor that uses NOPs. In an implementation, a NOP may be explicitly defined in the architecture or may be an instruction or instruction set that operates like a NOP. A result of replacing NOPs with auxiliary code may be maintaining the overall code size and thereby not impacting the main task performance.

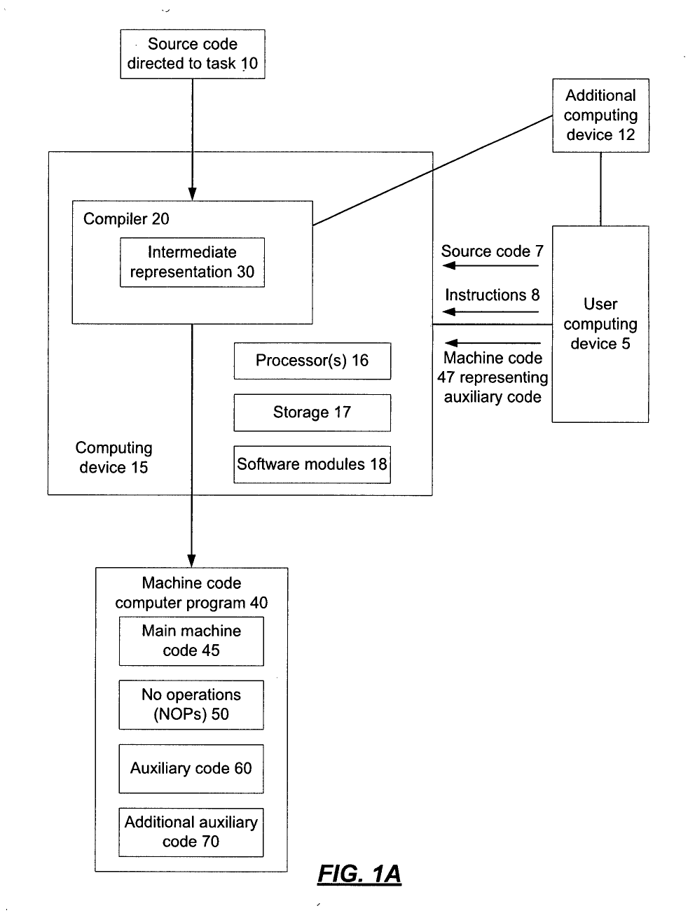

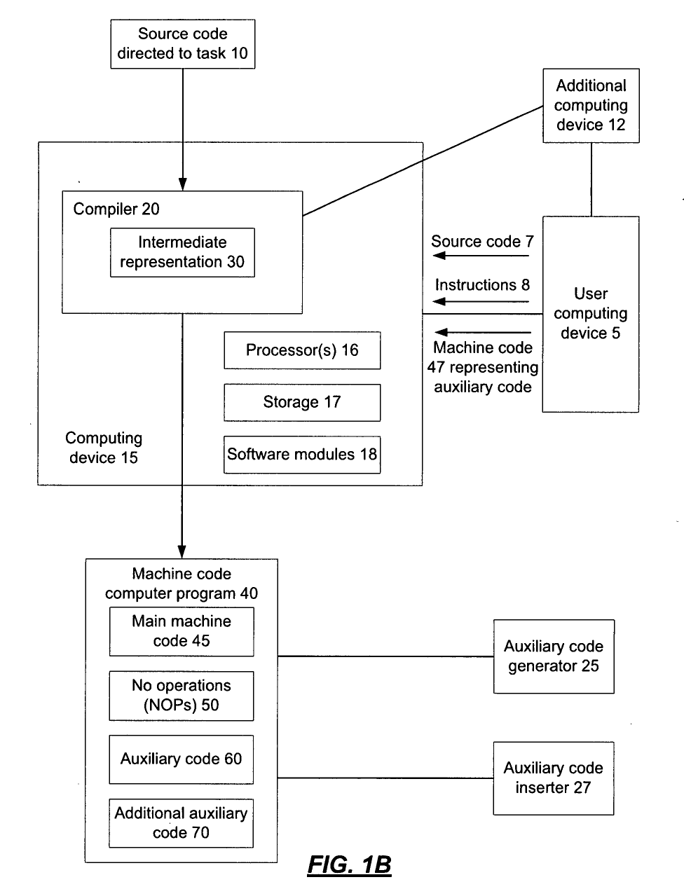

FIG. 1A is a block diagram of an implementation of a system that may be used to replace NOPs with auxiliary code. Source code 10 directed to a main task may be provided to a compiler 20, which may generate an intermediate representation 30. The compiler 20 may generate a machine code computer program 40 based on the intermediate representation 30.

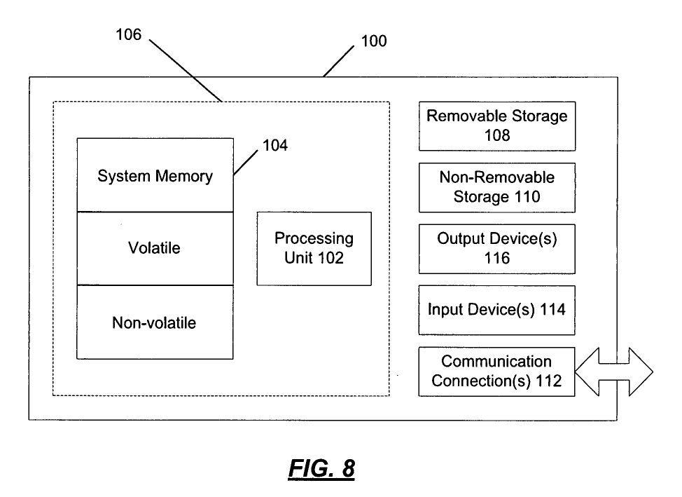

In an implementation, the compiler may reside in a computing device 15. A user, such as a programmer or software developer, may use a user computing device 5 to interact with the compiler 20 and its associated computing device 15. The user computing device 5 may be remote from the compiler 20 and in communication with the compiler 20. The computing device 15 may have one or more processors 16, storage 17 (e.g., storage devices, memory, etc.), and software modules 18. The computing device 15, including its processor(s) 16, storage 17, and software modules 18, may be used in the performance of the example methods described herein. Example software modules may include modules for receiving and acting on instructions related to auxiliary code, replacing NOPs with auxiliary code, and executing code, described further herein. While specific functionality is described herein as occurring with respect to specific modules, the functionality may likewise be performed by more, fewer, or other modules. The functionality may be distributed among more than one module. An example computing device and its components are described in more detail with respect to FIG. 8.

In another implementation, the compiler 20 may be comprised within the user computing device 5. One or more additional computing devices, such as an additional computing device 12, may also be in communication with the compiler 20, the computing device 15, the user computing device 5, or a combination thereof. An example user computing device or additional computing device is described with respect to FIG. 8.

A compiler is a computer program or set of programs that translates text written in a computer language, the source code, into another computer language, the machine code. A compiler may perform operations such as lexical analysis, preprocessing, parsing, semantic analysis, code generation, and code optimization, for example.

A compiler typically has a front end that analyzes the source code to build an internal representation of the program, called an intermediate representation. A middle end in a compiler is typically designed to perform optimizations on the intermediate representation, and provide its output to a back end. The back end may perform more analysis, transformations, and optimizations that are for a particular computer, and may generate machine code for a particular processor and operating system. The translation of the intermediate representation into the machine code involves resource and storage decisions, such as deciding which variables to fit into registers and memory and the selection and scheduling of appropriate machine instructions along with their associated addressing modes.

The machine code computer program 40 may comprise main machine code 45 directed to the main task and may contain one or more NOPs 50. Compilers insert NOPs into machine code for timing purposes, to force memory alignment, or to occupy a branch delay slot, or other reasons, for example. Some or all of the NOPs 50 may be replaced with auxiliary code 60, also in machine code as noted above. Alternatively, the machine code computer program 40 may be generated with auxiliary code 60 where the NOPs would otherwise be. In some implementations, additional auxiliary code 70 may also be provided in the machine code computer program 40. The auxiliary code 60 and additional auxiliary code 70 may be written in machine code and may be orthogonal to the main task that the main machine code 45 is directed to, as the auxiliary code 60 and additional auxiliary code 70 are not pertinent to the functionality of the main machine code 45. As used herein, the term “orthogonal” may be defined to mean directed to an unrelated task.

The auxiliary code 60 and additional auxiliary code 70 may comprise instructions that provide additional information about the machine code computer program 40 in which they reside and its execution, but otherwise may act as NOPs with regard to the functionality of the machine code computer program 40. This information may, for example, provide information that is useful for debugging, profiling, performance, fault-tolerance, or security, or other program aspects that are orthogonal to the functionality of the machine code computer program 40, described further below.

The auxiliary code 60 or additional auxiliary code 70 or both that may be inserted into the machine code computer program 40 may be created by a programmer or software developer or other user, for example, using a user computing device 5 or an additional computing device 12. In an implementation, the auxiliary code 60, the additional auxiliary code 70, or both, may be generated by the compiler 20. The user computing device 5 may provide source code 7 to the compiler 20 for generation of the auxiliary code 60 and any additional auxiliary code 70 during compilation, or may provide other instructions 8 to the compiler 20 for generating the auxiliary code 60 and any additional auxiliary code 70.

As noted above, there typically is an intermediate representation 30 generated by a compiler 20 before final compilation into the machine code computer program 40. The auxiliary code 60 and any additional auxiliary code 70 could be provided, in intermediate representation form instead of as machine code, after the intermediate representation 30 is generated and before the machine code computer program 40 is, generated. Alternatively, the user computing device 5 may provide the auxiliary code 60 and additional auxiliary code 70 as machine code 47 that is to be inserted directly into the machine code computer program 40 after it has been generated by the compiler 20.

After the auxiliary code 60 and additional auxiliary code 70 are generated or received, they may be inserted into the machine code computer program 40, by the compiler 20, the user computing device 5, or an additional computing device 12, for example.

FIG. 1B is a block diagram of another implementation of a system that may be used to replace NOPs with auxiliary code. FIG. 1B contains elements similar to those described above with respect to FIG. 1A. These elements are labeled identically and their description is omitted for brevity.

FIG. 1B includes an auxiliary code generator 25 and an auxiliary code inserter 27. In an implementation, the auxiliary code 60, the additional auxiliary code 70, or both, may be generated by the auxiliary code generator 25 alone or in conjunction with the compiler 20. Similarly, the auxiliary code 60 and/or additional auxiliary code 70 may be inserted into the machine code computer program 40 by the auxiliary code inserter 27 alone or in conjunction with the compiler 20. The auxiliary code generator 25 and the auxiliary code inserter 27 may be comprised within the user computing device 5, the additional computing device 12, or the computing device 15, for example.

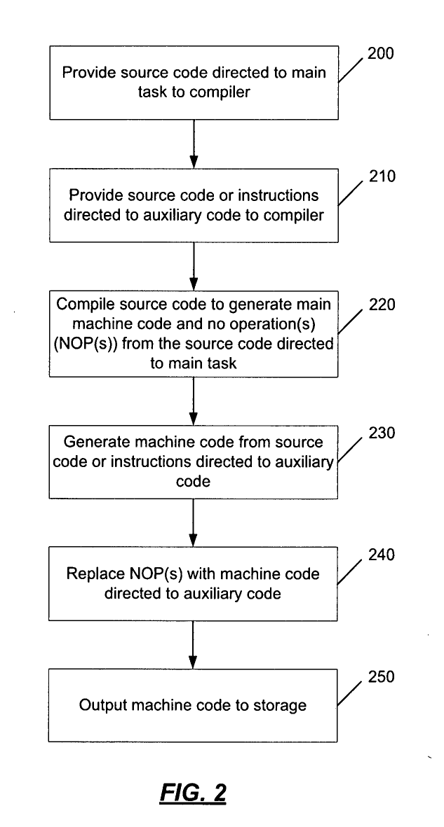

FIG. 2 is an operational flow of an implementation of a method of replacing one or more NOPs with auxiliary code. At operation 200, source code directed to a main task may be provided to a compiler. At operation 210, auxiliary code in the form of source code, or instructions pertaining to generation of auxiliary code, may be provided to the compiler. The instructions to the compiler may include auxiliary code in intermediate representation form or machine code form, instead of as source code, though the instructions are not limited to these forms.

At operation 220, the compiler may compile source code to generate a machine code computer program comprising main machine code including one or more NOPs directed to the main task, based on the previously received source code directed to the main task. The compiler may generate machine code directed to the auxiliary code, at operation 230, and may replace the NOP(s) with the machine code based on the auxiliary code, at operation 240. At operation 250, the machine code directed to the main task and comprising the machine code directed to the auxiliary code may be outputted to storage.

Alternatively, the compiler may generate main machine code directed to the main task and machine code directed to the auxiliary code in a single pass, inserting the auxiliary code (in machine code form) into the main machine code directed to the main task where the NOP(s) would otherwise be. In such an implementation, the NOP(s) may not be generated that may later be replaced by auxiliary code; instead, the auxiliary code may be inserted into the main machine code directed to the main task, without an intermediate operation of NOP generation.

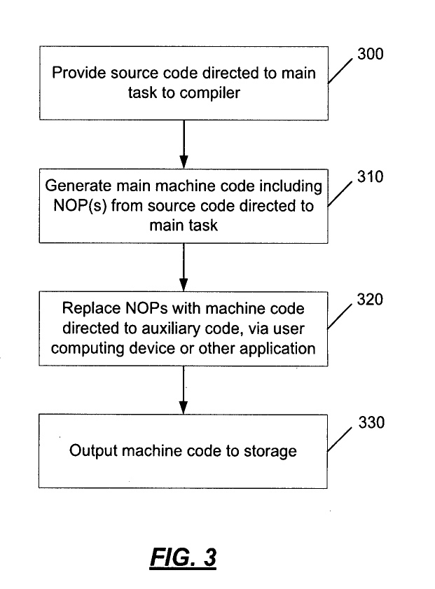

FIG. 3 is an operational flow of another implementation of a method of replacing one or more NOPs with auxiliary code. At operation 300, the source code for a main task may be provided to a compiler. At operation 310, the compiler may generate a machine code computer program comprising main machine code including one or more NOPs directed to the main task. At operation 320, a user via a user computing device, or another application, may replace the NOP(s) with machine code directed to auxiliary code, directly into the machine code computer program generated by the compiler. At operation 330, the machine code directed to the main task and comprising the machine code directed to the auxiliary code may be outputted to storage.

The implementations described with respect to FIGS. 2 and 3 assume that there are enough NOPs to accommodate all of the auxiliary code (in machine code form). In an implementation, this may be determined by comparing the amount of register space used by the NOPs to the amount of register space that may be used by the auxiliary code. If the amount of register space used by the NOPs is greater than or equal to the amount of register space that may be used by the auxiliary code, then it may be determined that there are enough NOPs in the machine code computer program to accommodate the auxiliary code.

In some situations, however, there may not be enough NOPs in the machine code computer program to accommodate all of the auxiliary code. If this is the case, in an implementation, the compiler may not replace any NOPs with machine code based on auxiliary code. Thus, the auxiliary code may be disregarded and discarded.

In another implementation, if there may not be enough NOPs in the machine code computer program to accommodate all of the auxiliary code, the compiler may replace the available NOPs with some of the machine code based on the auxiliary code, and then separately include some or all of the remaining machine code based on the auxiliary code into the machine code computer program. This separately included auxiliary code may be referred to as additional auxiliary code, such as additional auxiliary code 70 in implementations described with respect to FIG. 1A and FIG. 1B. In this manner, the overall size of the generated machine code computer program may be increased, compared to the size of the generated machine code computer program if the auxiliary code were not included.

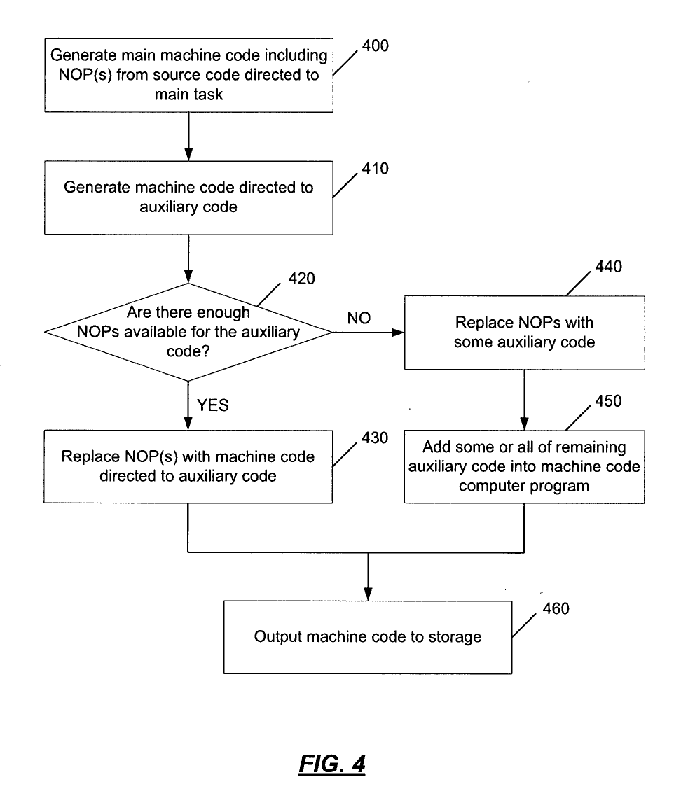

FIG. 4 is an operational flow of an implementation of a method of replacing NOPs with auxiliary code based on the availability of NOPs. At operation 400, a machine code computer program, including one or more NOPs, may be generated responsive to previously received source code directed to a main task. At operation 410, the compiler may generate machine code directed to auxiliary code.

At operation 420, it may be determined if there are enough NOPs available in the machine code computer program so that all of the auxiliary code may replace them or at least a portion of them. If so, the auxiliary code (in machine code form) may replace the NOPs, at operation 430. Otherwise, at operation 440, the compiler may replace the NOPs with some of the machine code based on the auxiliary code. At operation 450, some or all of the machine code based on the auxiliary code that did not replace the NOPs, i.e. additional auxiliary code, may be separately incorporated or otherwise added into the machine code computer program. At operation 460, the machine code directed to the main task and comprising machine code directed to the auxiliary code may be outputted to storage.

In an implementation, the auxiliary code may have been previously indicated to be either desired or superfluous. Auxiliary code that is indicated to be desired may be incorporated into a machine code computer program even if NOPs are not available to replace, while auxiliary code that is indicated to be superfluous may be discarded and not incorporated into the machine code computer program if NOPs are not available. A user, such as a programmer or software developer, may provide an indication as to whether the auxiliary code, or which functionality of the auxiliary code, should be discarded if there are no NOPs available in which to place the auxiliary code, or should be included as separate machine code, thereby increasing the size of the generated machine code computer program.

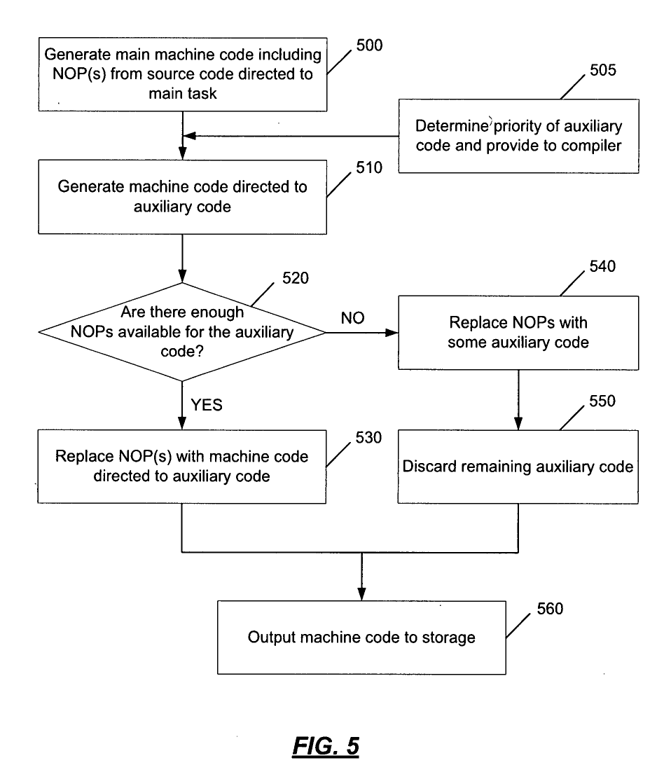

In another implementation, as described with respect to the operational diagram of FIG. 5, the compiler may replace the available NOPs with some of the machine code based on the auxiliary code, and discard the remaining auxiliary code. Because auxiliary code is orthogonal to the main machine code based on the main task, the functionality of the main machine code directed to the main task may not be affected.

FIG. 5 is an operational flow of another implementation of a method of replacing NOPs with auxiliary code based on the availability of NOPs. Operations 500 through 540 are similar to operations 400 through 440. At operation 500, a machine code computer program with one or more NOPs may be generated responsive to previously received source code directed to a main task. The compiler may generate machine code directed to auxiliary code, at operation 510.

The auxiliary code may be prioritized as to which auxiliary code, or functionality of the auxiliary code, should be maintained ahead of other auxiliary code or functionality of auxiliary code, if some of the auxiliary code is ultimately discarded as described further below. In an implementation, priority information may be determined by a user or application and may be provided to the compiler, at operation 505. The compiler may use the priority information during or after compilation.

At operation 520, it may be determined if there are enough NOPs available for the machine code directed to the auxiliary code to replace. If so, the machine code directed to the auxiliary code may replace the NOPS, at operation 530. Otherwise, at operation 540, the compiler may replace the NOPs with some of the machine code based on the auxiliary code. In an implementation, auxiliary code with a higher priority may replace NOPs ahead of auxiliary code with a lower priority. At operation 550, the remaining machine code based on the auxiliary code that did not replace the NOPs may be discarded. At operation 560, the machine code directed to the main task and comprising machine code directed to the auxiliary code may be outputted to storage.

Any type of auxiliary code, having any type of functionality, may be used or incorporated into machine code where some or all of the NOPs otherwise would be. Auxiliary code may comprise instructions that are directed to various types of functionality, such as assessing performance, debugging, profiling, fault tolerance, concurrency assertions, and checking security, for example. The instructions may be directed to gathering or indicating particular information regarding the machine code that is being executed.

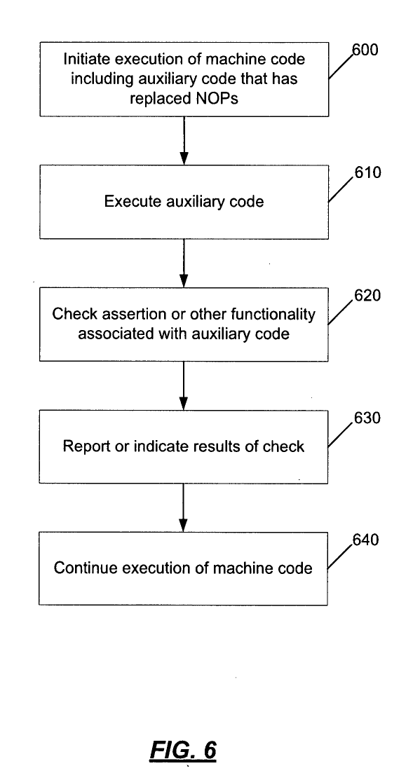

FIG. 6 is an operational flow of an implementation of a method of executing auxiliary code that has replaced one or more NOPs in main machine code, either directly or by placing the auxiliary code where the NOP(s) would otherwise be in the main machine code. At operation 600, an execution of the machine code, containing the auxiliary code, may be initiated. At some point during the execution of the machine code, at operation 610, the auxiliary code may be executed. An assertion or other functionality associated with the auxiliary code may be checked, at operation 620. The results of the check may be reported to a user or otherwise indicated, at operation 630. Machine code execution may continue, at operation 640, without any change in the functionality of the machine code.

Regarding the functionality of performance assessment, auxiliary code may be implemented that determines where a memory location stands in a hierarchy. In this manner, a user may be apprised as to how the machine code is performing, and perhaps make modifications that move the memory location into a higher hierarchy for quicker access. In an implementation, auxiliary code may contain instructions that move a particular memory location into a higher hierarchy. This may increase the performance of the machine code, while not affecting its functionality. In another implementation, the auxiliary code may comprise an assertion that a particular memory location is at a certain point in the hierarchy.

An implementation of auxiliary code directed to debugging may contain instructions that save a copy of a variable at some point during the execution of the machine code, prior to the variable being involved in further computations. In an implementation, such instructions may take the form of “move variable into stack”. The saved copy of the variable may then be used in a subsequent analysis or debugging of the machine code.

Profiling refers to auxiliary code that may be used to get an estimate as to how much work has been done by a particular function that is involved in computation in machine code. In an implementation, instructions that may replace one or more NOPs may keep track of how much processing time or how many processor cycles, for example, a particular function has used to a particular point in the execution of the machine code.

Auxiliary code directed to fault tolerance may perform various checks on computations, such as the results of arithmetic. In an implementation, when a number is multiplied by two, the result should be even. In such a case, auxiliary code may be inserted to replace one or more NOPs that checks that the result is even. An assertion such as “the result should be even” may be implemented. In another implementation, certain bits resulting from a computation may be checked, such as to confirm that they are the expected values. Example assertions may be “the low order bits are zero” or “the low order bits are non-zero”, and a notification may be provided to the user depending on whether the assertion is determined to be true or false.

Concurrency assertions may be implemented in auxiliary code that replaces NOPs. In an implementation, auxiliary code may replace one or more NOPs in machine code and may determine how many threads are active in the machine code at a particular point in the code. An assertion such as “there should be X number of threads at this point”, where X is a predetermined number, may be implemented. A notification may be provided to the user depending on whether the assertion turns out to be true or false. In another implementation, auxiliary code that may replace one or more NOPs in machine code may be directed to a counter that estimates an amount of contention by summing a queue length on entry to a mutex and counting the entries. A mutex is a mutual exclusion object that allows multiple threads to synchronize access to a shared resource.

In an implementation, auxiliary code that may replace one or more NOPs may be directed to security hints to ensure control flow integrity (CFI) or data flow integrity (DFI). CFI and DFI are known techniques that may provide program security and may use information that is encoded in the machine code. Previous CFI and DFI techniques inserted additional information into the sequence of instructions in the machine code, which results in larger programs that may affect the program performance due to increased instruction cache pressure, resulting in additional instruction cache misses. Auxiliary code that may replace NOPs with respect to security is not limited to CFI and DFI techniques, as any security checks or assertions that may be implemented as auxiliary code in machine code is contemplated.

In an implementation, the CFI and DFI information may provide guidance about what may be considered proper program and data behavior, thereby restricting malicious behavior. This security information is orthogonal to the functionality of the program being executed. By replacing NOPs in the machine code with the CFI and DFI information or other information, the information may be provided in the machine code without increasing its size.

In an implementation directed to CFI, in the machine code at a computed jump (also known as an indirect jump or indirect branch), auxiliary code may replace a NOP, if available, that checks that the jump is to be made to a particular location. If the jump is not being made to the location indicated in the auxiliary code, then an indication or exception may be triggered, indicating an inconsistency between the location in the auxiliary code and the destination of the jump. Alternatively or additionally, instructions such as CFI label instructions may be inserted in place of NOPs at the destination of such jumps, to assert that control flow stems from valid origins, through permitted jump instructions.

It is contemplated that auxiliary code may replace one or more NOPs in CFI techniques that use basic blocks or super blocks or both. A basic block comprises a sequence of instructions, such as four to seven instructions, executed in sequence pursuant to a branch in instruction, and then exiting via a branch out instruction. Super blocks may be a collection of basic blocks. Super blocks may provide more NOPs that may be replaced by auxiliary code.

DFI relates to the history of the data that is being used by the machine code. In an implementation, memory locations that are used by the machine code may be marked. The memory locations may store data, and auxiliary code, which may have replaced NOPs in the machine code, may check that only marked memory locations are being used by the machine code. If memory locations other than those marked are being used, as detected by the auxiliary code, then an indication or exception may be triggered.

A portion of an implementation of assembly code representing main machine code for a main task is provided below. The portion of assembly code reproduced below comprises two NOPs, though assembly code or machine code may comprise any number of NOPs. The NOPs may be replaced by auxiliary code directed to various functionalities.

| | |
|---|---|
| .l2: | |
| srl | %o0,1,%g2 |
| btst | 1,%o0 |
| bne | .l3 |
| nop | |
| inc | %i2 |
| srl | %o0,1,%o0 |
| ba | .l4 |
| nop | |

Various implementations of replacing a NOP with auxiliary code in the portion of assembly code above are provided. In an implementation, for security, a CFI label instruction may replace a NOP. In an implementation, for debugging, a NOP may be changed to an instruction to move a copy of a return address to a register, or to global memory location, so that it is present, even if the machine code computer program crashes in a manner that corrupts data such as the stack. For profiling, in an implementation, a NOP may be replaced by an instruction that is directed to incrementing a global counter that indicates how often this function is called. Alternatively or additionally for profiling in an implementation, the NOP may be replaced by an instruction that is directed to maintaining a maximum value of a variable, using a conditional move instruction or another appropriate instruction, for example.

In an implementation, for performance, the NOP may be changed to a prefetch operation on the data of the argument string that may be used by a subsequent print function. For fault tolerance, in an implementation, an instruction may replace a NOP to check that the function is being called from a particular place. This may involve checking that all the top bits in the return address are a certain value. Alternatively or additionally for fault tolerance in an implementation, a NOP may be replaced by an instruction that checks that a particular register always holds a particular or reasonable value. This may involve checking that all its top or low bits in the return address are a certain value to assert the alignment and magnitude of the register.

In an implementation, the handling of exceptions generated by the auxiliary code, or the results of whatever functionality is being monitored by the auxiliary code, may be delayed, as long as the state of the machine with respect to the auxiliary code does not change. This provides flexibility to the programmer or software developer or other user, and may lead to a reduction in size of the machine code computer program.

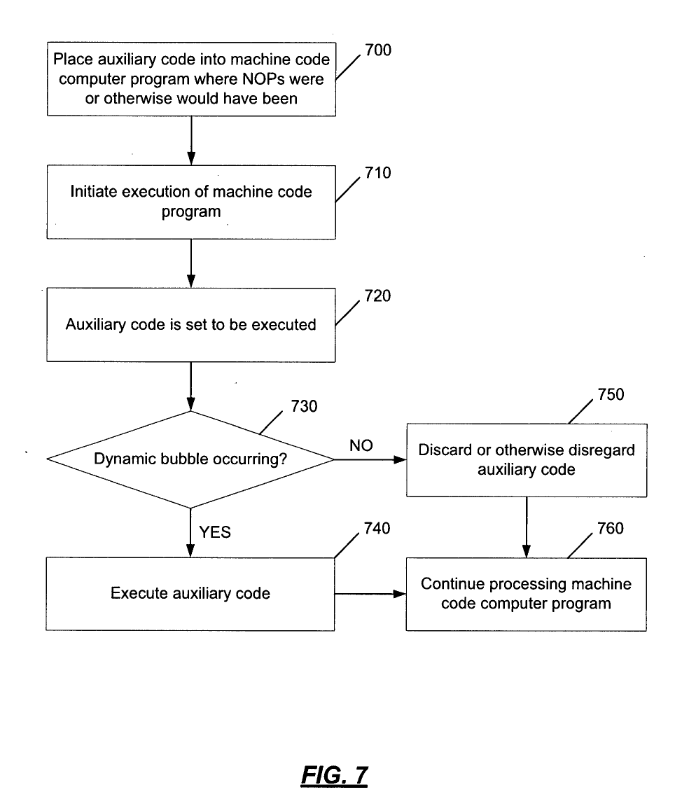

A dynamic bubble may occur in a processor when it is idling. In an implementation, auxiliary code may be run only when a dynamic bubble is occurring. FIG. 7 is an operational flow of an implementation of a method in which a dynamic bubble may be used in conjunction with auxiliary code. At operation 700, auxiliary code (in machine code form) may be placed into a previously generated machine code computer program, where NOPs previously were or otherwise would have been or as additional code.

At operation 710, execution of the machine code computer program may begin. At some point, at operation 720, the auxiliary code may be set to be executed, in the machine code instruction sequence. Prior to execution of the auxiliary code, at operation 730, it may be determined whether or not a dynamic bubble is occurring with respect to the processor. If a dynamic bubble is occurring, then the auxiliary code may be executed, at operation 740. Otherwise, the auxiliary code may be treated as a NOP and discarded or otherwise disregarded at operation 750, and processing of the machine code computer program may continue at operation 760.

The conditional execution of auxiliary code may be implemented using predicated instructions or using a flag, for example. In an implementation, a flag may be set when a dynamic bubble is occurring, and the auxiliary code may be executed unless the flag is set. So in an implementation, if the flag is off or not set, the auxiliary code may be executed. Alternatively, in another implementation, a flag may be set when there is no dynamic bubble occurring, and may be turned off when a dynamic bubble occurs. In such an implementation, the auxiliary code may be executed if the flag is set.

The examples, techniques, and systems described herein are by no means restricted to machine code only, and may be applied to any computer program or instruction set that has some form of no operations or idle processing. Additionally, the examples, techniques, and systems described herein are by no means restricted to use with a compiler, and may be used in conjunction with any software or hardware or combination that interacts with a computer program. The availability of no operations or idle processing is not required, but may reduce the overall size of the instructions and data that may be processed, as well as the processing time.

### Exemplary Computing Arrangement

FIG. 8 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 8, an exemplary system for implementing aspects described herein includes a computing device, such as computing device 100. In its most basic configuration, computing device 100 typically includes at least one processing unit 102 and memory 104. Depending on the exact configuration and type of computing device, memory 104 may be volatile (such as random access memory (RAM)), non-volatile (such as read-only memory (ROM), flash memory, etc.), or some combination of the two. This most basic configuration is illustrated in FIG. 8 by dashed line 106.

Computing device 100 may have additional features/functionality. For example, computing device 100 may include additional storage (removable and/or non-removable) including, but not limited to, magnetic or optical disks or tape. Such additional storage is illustrated in FIG. 8 by removable storage 108 and non-removable storage 110.

Computing device 100 typically includes a variety of computer readable media. Computer readable media can be any available media that can be accessed by device 100 and includes both volatile and non-volatile media, removable and non-removable media.

Computer storage media includes volatile and non-volatile, removable and non-removable media implemented in any method or technology for storage of information such as computer readable instructions, data structures, program modules or other data. Memory 104, removable storage 108, and non-removable storage 110 are all examples of computer storage media. Computer storage media includes, but is not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of computing device 100.

Computing device 100 may contain communications connection(s) 112 that allow the device to communicate with other devices. Computing device 100 may also have input device(s) 114 such as a keyboard, mouse, pen, voice input device, touch input device, etc. Output device(s) 116 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computer-readable medium comprising computer-readable instructions for optimizing a computer program, said computer-readable instructions comprising instructions that:
receive source code at a compiler;
compile the source code into machine code, the machine code comprising a no operation (NOP);
replace the NOP with auxiliary code, the functionality of the auxiliary code being orthogonal to the functionality of the machine code; and
output the machine code to storage.

2. The computer-readable medium of claim 1, wherein the auxiliary code comprises information directed to debugging, profiling, performance, fault-tolerance, or security.

3. The computer-readable medium of claim 1, wherein the auxiliary code comprises security hints to ensure control flow integrity (CFI) or data flow integrity (DFI).

4. The computer-readable medium of claim 1, wherein the instructions that replace the NOP with auxiliary code comprise instructions that receive the auxiliary code from a user via a computing device.

5. The computer-readable medium of claim 1, further comprising instructions that add additional auxiliary code to the machine code.

6. The computer-readable medium of claim 1, wherein the auxiliary code is executable only if a processor running the auxiliary code is idling.

7. The computer-readable medium of claim 1, further comprising instructions that:
execute the machine code and auxiliary code;
check the functionality of the auxiliary code;
indicate a result of the checking the functionality of the auxiliary code; and
continue executing the machine code.

8. A method of optimizing a computer program, comprising:
receiving machine code directed to a task, the machine code comprising at least one no operation (NOP);
receiving auxiliary code;
comparing an amount of NOPs to the amount of auxiliary code to determine whether there are enough NOPs in the machine code so that all of the auxiliary code may replace at least a portion of the at least one NOP; and
if so, then replacing the portion of the at least one NOP with all of the auxiliary code.

9. The method of claim 8, wherein if there is more auxiliary code than NOPs in the machine code, then discarding the auxiliary code.

10. The method of claim 8, wherein if there is more auxiliary code than NOPs in the machine code, then replacing the NOPs with a portion of the auxiliary code.

11. The method of claim 10, wherein if there is more auxiliary code than NOPs in the machine code, then further comprising discarding a second portion of the auxiliary code.

12. The method of claim 11, wherein the second portion of the auxiliary code is indicated to be superfluous prior to discarding.

13. The method of claim 10, wherein if there is more auxiliary code than NOPs in the machine code, then further comprising adding a second portion of the auxiliary code to the machine code directed to the task.

14. The method of claim 13, wherein the second portion of the auxiliary code is indicated to be desired to be retained prior to adding to the machine code directed to the task.

15. The method of claim 8, further comprising prioritizing the auxiliary code to indicate which portion of the auxiliary code is more desirable to retain than another portion of the auxiliary code.

16. A computing system, comprising:
a compiler that generates a machine code computer program comprising machine code directed to a task and auxiliary code in place of where a no operation (NOP) otherwise would be in the machine code directed to the task; and
a storage device that stores the machine code computer program.

17. The system of claim 16, wherein the compiler generates the machine code computer program comprising the NOP and replaces the NOP with the auxiliary code.

18. The system of claim 16, wherein the machine code computer program comprises additional auxiliary code added to the machine code directed to the task.

19. The system of claim 16, wherein the auxiliary code is orthogonal to the functionality of the code.

20. The system of claim 16, wherein the auxiliary code is executable only if a processor running the auxiliary code is idling.
